(19) United States
(12) Patent Application Publication
(10) Pub. No.: US 2023/0109892 A1
(43) Pub. Date: Apr. 13, 2023

(54) Bipolar Plate for Fuel Cell and Method for Preparing Same

(71) Applicant: Robert Bosch GmbH, Stuttgart (DE)

(72) Inventors: Bicheng Chen, Shanghai (CN); Xu Zhang, Shanghai (CN); Xu Xie, Shanghai (CN)

(21) Appl. No.: 17/961,068

(22) Filed: Oct. 6, 2022

(30) Foreign Application Priority Data
Oct. 9, 2021 (CN) 202111174421.2

(51) Int. Cl. H01M 4/88; H01M 4/86

(52) U.S. Cl. CPC H01M 4/8875; H01M 4/8631; H01M 2004/8694

(57) ABSTRACT

A method of preparing a bipolar plate for a fuel cell is disclosed. The method includes (a) using an electrically conductive filler and a polymer binder to prepare a bipolar plate blank, (b) vacuum-sealing the bipolar plate blank in a metal foil bag, (c) applying hot isostatic pressing to the bipolar plate blank vacuum-sealed in the metal foil bag at a pressure greater than 100 MPa and a temperature of 150-400° C., and (d) peeling the bipolar plate blank that has undergone the hot isostatic pressing from the metal foil bag, and thereby obtaining the bipolar plate. A bipolar plate prepared by the method is also disclosed.

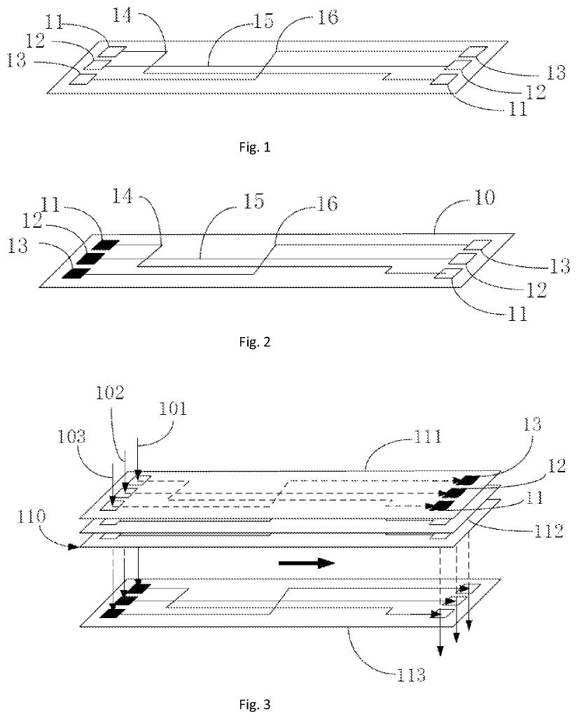

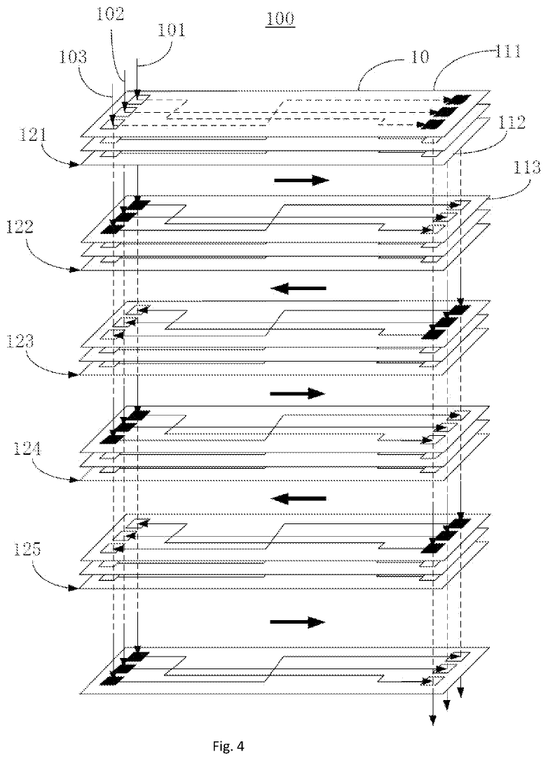

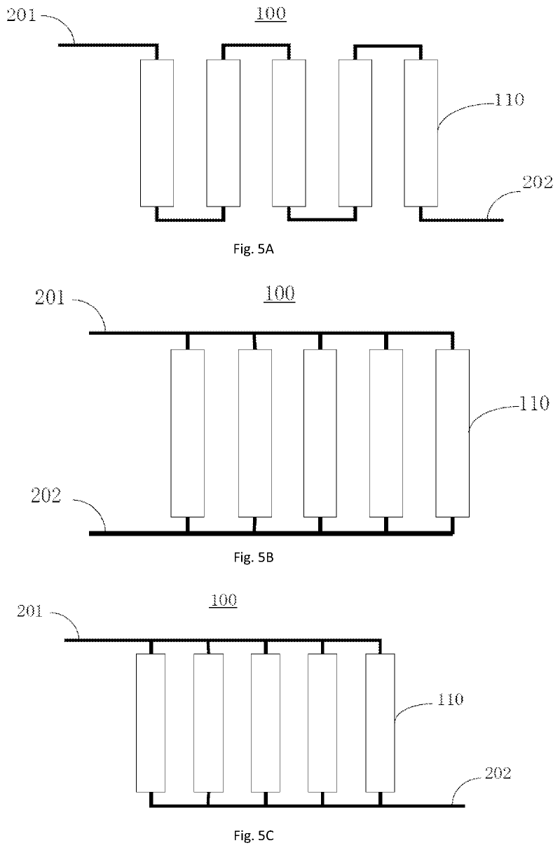

This application claims priority under 35 U.S.C. § 119 to patent application no. CN 202111174421.2, filed on Oct. 9, 2021 in China, the disclosure of which is incorporated herein by reference in its entirety.

The present disclosure provides a method of preparing a bipolar plate for a fuel cell, and a bipolar plate thus prepared.

### BACKGROUND

Proton exchange membrane fuel cells (PEMFC) use hydrogen as fuel, converting chemical energy to electrical energy electrochemically, and discharging water, thus achieving zero emissions in a true sense. In addition to having characteristics of ordinary fuel cells, namely high efficiency, no pollution, no noise and the ability to operate continuously, PEMFCs also have advantages such as high power density, low operating temperature, quick starting and a long service life, due to the use of a solid polymer membrane as an electrolyte. Thus, PEMFCs are an efficient and environmentally friendly power source with broad application prospects, and in particular may be used in electric vehicles (such as cars), stationary power plants and portable devices.

Bipolar plates are a major multifunctional constituent component of PEMFCs. The functions of bipolar plates include supporting the membrane electrodes, distributing fuel and oxidant, isolating single cells in the cell stack, collecting current and conducting electricity between single cells, discharging water and transferring heat, etc. Thus, bipolar plates need to have low weight, high electrical conductivity, low gas permeability, high strength, high thermal conductivity, low cost, corrosion resistance and pressure stability.

Bipolar plate materials currently in common use include carbon (e.g. graphite), electrically conductive filler/polymer composites (e.g. graphite fibre composites), and metals or alloys (e.g. stainless steel, titanium, aluminium, nickel, iron alloys, nickel alloys or aluminium alloys). However, the processing of all of these bipolar plate materials involves problems that need to be mitigated. For example, graphite has high porosity, low mechanical strength and poor processability; production is only possible by engraving, so the production cost is high. Iron alloys and nickel alloys need to undergo embossing and spreading, so the production cost is high; and aluminium alloys have poor corrosion resistance.

Taking a graphite/binder composite material bipolar plate as an example, an existing preparation process comprises: mixing about 80 wt % graphite with about 20 wt % binder, compression moulding the resulting mixture while heating for several minutes at a temperature of about 200° C. and a pressure of about 100 MPa, then demoulding, thereby obtaining the graphite/binder composite material bipolar plate. However, the high content of binder results in low electrical conductivity. If the binder content is low, the porosity of the bipolar plate will be high, gas isolation will drop, and the density will be low, giving rise to problems such as low mechanical strength. Conversely, if the binder content is increased, the electrical conductivity will fall; it is not possible to increase both the electrical conductivity and the mechanical strength at the same time.

Thus, there is a need to constantly improve bipolar plates for PEMFCs and the methods by which they are prepared, in order to provide bipolar plates with high electrical conductivity and low gas permeability.

### SUMMARY

To this end, in one aspect, the present disclosure provides a method of preparing a bipolar plate for a fuel cell, comprising:
a) using an electrically conductive filler and a polymer binder to prepare a bipolar plate blank,
b) vacuum-sealing the bipolar plate blank in a metal foil bag,
c) applying hot isostatic pressing to the bipolar plate blank vacuum-sealed in the metal foil bag at a pressure greater than 100 MPa and a temperature of 150-400° C., and
d) peeling the bipolar plate blank that has undergone the hot isostatic pressing from the metal foil bag, and thereby obtaining the bipolar plate.

The present disclosure also provides a bipolar plate for a fuel cell, in particular for a PEMFC, the bipolar plate being prepared by the method of the present disclosure.

The PEMFC according to the present disclosure may be used in electric vehicles (such as cars), regional power plants and portable devices.

After in-depth research, the inventors of the present disclosure introduced the step of hot isostatic pressing into the bipolar plate preparation method; by using a pressure that is greater than, in particular several times that of a compression-moulding step in the prior art, a much lower porosity can be achieved while using a small amount of binder, thereby greatly increasing the bipolar plate's density, electrical conductivity and mechanical strength.

### DETAILED DESCRIPTION

Unless otherwise defined, all technical and scientific terms used herein have the means commonly understood by those skilled in the art. In case of inconsistency, the definitions provided in the present application shall be definitive.

Unless otherwise indicated, numerical ranges set out herein are intended to include the endpoints of the ranges, as well as all values and all sub-ranges within the ranges.

All materials, contents, methods, equipment, drawings and examples herein are exemplary, and unless specifically stated, should not be understood to be restrictive.

The terms “containing”, “comprising” and “having” used herein all mean that other components or other steps that do not affect the final result may be included. These terms encompass the meanings of “consisting of . . . ” and “substantially consisting of . . . ”. The products and methods according to the present disclosure may contain or comprise necessary technical features described in this disclosure, as well as additional and/or optionally present components, constituents, steps or other limiting features described herein; or may consist of necessary technical features described in this disclosure, as well as additional and/or optionally present components, constituents, steps or other limiting features described herein; or substantially consist of necessary technical features described in this disclosure, as well as additional and/or optionally present components, constituents, steps or other limiting features described herein.

Unless otherwise explicitly stated, all materials and reagents used in this disclosure are commercially available.

Unless otherwise indicated or there is obvious contradiction, all operations performed herein may be performed at room temperature and atmospheric pressure.

Unless otherwise indicated or there is obvious contradiction, the method steps in this disclosure may be performed in any suitable sequence.

In this disclosure, the word “about” means that the value defined thereby can vary within a range of the value ±10% of the value. For example, “about 6 minutes” means “5.4 — 6.6 minutes”.

Examples of this disclosure are described in detail below.

A PEMFC comprises a proton exchange membrane, a catalyst layer, a gas diffusion layer and a bipolar plate.

The present disclosure provides a method of preparing a bipolar plate for a fuel cell, comprising:
a) using an electrically conductive filler and a polymer binder to prepare a bipolar plate blank,
b) vacuum-sealing the bipolar plate blank in a metal foil bag,
c) applying hot isostatic pressing to the bipolar plate blank vacuum-sealed in the metal foil bag at a pressure greater than 100 MPa and a temperature of 150-400° C., and
d) peeling the bipolar plate blank that has undergone the hot isostatic pressing from the metal foil bag, and thereby obtaining the bipolar plate.

In some examples, taking into account the cost efficiency of actual operations, in step c), hot isostatic pressing is applied to the bipolar plate blank vacuum-sealed in the metal foil bag at a pressure greater than 300 MPa and a temperature of 200-300° C.; the hot isostatic pressing preferably lasts for more than 1 minute, more preferably for 5-10 minutes, and further preferably for about 6 minutes.

In some examples, in step a), the step of preparing a bipolar plate blank comprises:
a1) mixing the electrically conductive filler and the polymer binder,
a2) compression-moulding the mixture obtained in step a1), and
a3) demoulding the compression-moulded mixture, thereby obtaining the bipolar plate blank.

As stated above, in a conventional process for preparing a bipolar plate, the pressure in a compression-moulding step can only apply pressure to the bipolar plate blank in a single direction, e.g. can only apply pressure to the bipolar plate blank in the direction of one dimension: up/down, left/right or front/rear, and the bipolar plate thereby obtained has a loose structure with low mechanical strength. To improve the mechanical properties of the bipolar plate, the binder content needs to be increased, but increasing the binder content will result in a drop in the bipolar plate's electrical conductivity. Thus, the conventional process for preparing a bipolar plate is unable to give consideration to electrical conductivity and mechanical strength at the same time.

After in-depth research, the inventors of the present disclosure introduced the step of hot isostatic pressing into the bipolar plate preparation method; by using a pressure that is greater than, in particular several times that of a compression-moulding step in the prior art, a much lower porosity can be achieved while using a small amount of binder, thereby greatly increasing the bipolar plate's density, electrical conductivity and mechanical strength.

Furthermore, according to the method of the present disclosure, the pressure in the compression-moulding step may be lower than a compression-moulding pressure used in a conventional process, as long as the bipolar plate blank obtained in the compression-moulding step is able to retain its shape. In the subsequent hot isostatic pressing step, the bipolar plate blank is subjected to isotropic pressure, and it is thereby possible to obtain a product of uniform density while stably retaining the shape of the bipolar plate blank.

In some examples, in step a), based on the total weight of the mixture of the electrically conductive filler and the polymer binder, the content of the electrically conductive filler is 80-99 wt %, preferably 90-99 wt %; and the content of the polymer binder is 1-20 wt %, preferably 1-10 wt %.

In some examples, in step a), the electrically conductive filler is a carbon-containing material, preferably selected from graphite, graphene, carbon nanotubes or a combination thereof; and the graphite is preferably selected from flake graphite, ultrafine graphite, expandable graphite or a combination thereof.

In some examples, in step a), the polymer binder is selected from phenolic resin, epoxy resin, vinyl ester (VE), polyimide, polypropylene or a combination thereof.

In some examples, in step b), the metal foil bag is made of a material selected from copper foil and nickel foil.

In some examples, the fuel cell is a PEMFC.

The present disclosure also provides a bipolar plate for a fuel cell, in particular for a PEMFC, the bipolar plate being prepared by the method of the present disclosure.

What is claimed is:

1. A method of preparing a bipolar plate for a fuel cell, comprising:
a) using an electrically conductive filler and a polymer binder to prepare a bipolar plate blank,
b) vacuum-sealing the bipolar plate blank in a metal foil bag,
c) applying hot isostatic pressing to the bipolar plate blank vacuum-sealed in the metal foil bag at a pressure greater than 100 MPa and a temperature of 150-400° C., and
d) peeling the bipolar plate blank that has undergone the hot isostatic pressing from the metal foil bag, and thereby obtaining the bipolar plate.

2. The method as claimed in claim 1, wherein in step a), the step of preparing a bipolar plate blank comprises:
a1) mixing the electrically conductive filler and the polymer binder,
a2) compression-moulding the mixture obtained in step a1), and
a3) demoulding the compression-moulded mixture, thereby obtaining the bipolar plate blank.

3. The method as claimed in claim 1, wherein in step a), based on the total weight of the mixture of the electrically conductive filler and the polymer binder, the content of the electrically conductive filler is 80-99 wt %, and the content of the polymer binder is 1-20 wt %.

4. The method as claimed in claim 1, wherein in step c), hot isostatic pressing is applied to the bipolar plate blank vacuum-sealed in the metal foil bag at a pressure greater than 300 MPa and a temperature of 200-300° C.

5. The method as claimed in claim 1, wherein in step b), the metal foil bag is made of a material selected from copper foil and nickel foil.

6. The method as claimed in claim 1, wherein in step a), the electrically conductive filler is a carbon-containing material, selected from graphite, graphene, carbon nanotubes or a combination thereof; and the graphite is selected from flake graphite, ultrafine graphite, expandable graphite or a combination thereof.

7. The method as claimed in claim 1, wherein in step a), the polymer binder is selected from phenolic resin, epoxy resin, vinyl ester, polyimide, polypropylene or a combination thereof.

8. The method as claimed in claim 1, wherein the fuel cell is a proton exchange membrane fuel cell.

9. A bipolar plate for a fuel cell, the bipolar plate being prepared by the method as claimed in claim 1.

10. The method as claimed in claim 1, wherein in step a), based on the total weight of the mixture of the electrically conductive filler and the polymer binder, the content of the electrically conductive filler is 90-99 wt %; and the content of the polymer binder is 1-10 wt %.

11. The method as claimed in claim 1, wherein in step c), hot isostatic pressing is applied to the bipolar plate blank vacuum-sealed in the metal foil bag at a pressure greater than 300 MPa and a temperature of 200-300° C.; the hot isostatic pressing lasts for more than 5-10 minutes.

12. The method as claimed in claim 1, wherein in step c), hot isostatic pressing is applied to the bipolar plate blank vacuum-sealed in the metal foil bag at a pressure greater than 300 MPa and a temperature of 200-300° C.; the hot isostatic pressing lasts for more than about 6 minutes.

13. The method as claimed in claim 4, wherein the hot isostatic pressing lasts for more than 1 minute.
